(19) United States
(12) Patent Application Publication
(10) Pub. No.: US 2019/0359085 A1
(43) Pub. Date: Nov. 28, 2019

(54) SEAT STORAGE SYSTEM AND SEAT POSTURE CHANGING SYSTEM

(71) Applicant: TOYOTA BOSHOKU KABUSHIKI KAISHA, Aichi-ken (JP)

(72) Inventors: Katsuhito Yamauchi, Aichi-ken (JP); Nobuki Hayashi, Aichi-ken (JP); Tokuyuki Nishikawa, Aichi-ken (JP); Takeshi Yamada, Aichi-ken (JP)

(73) Assignee: TOYOTA BOSHOKU KABUSHIKI KAISHA, Aichi-ken (JP)

(21) Appl. No.: 16/418,508

(22) Filed: May 21, 2019

(30) Foreign Application Priority Data
May 23, 2018 (JP) 2018-098610
May 23, 2018 (JP) 2018-098612

(51) Int. Cl. B60N 2/02; B60N 2/06; B60N 2/00

(52) U.S. Cl. CPC B60N 2/0292; B60N 2/06; B60N 2/0244; B60N 2002/247; B60N 2002/0268; B60N 2002/0272; B60N 2/002

(57) ABSTRACT

A seat storage system, wherein a controller is configured to, in a case where a seating determiner confirms that no sitting person is seated on a seat surface portion of any one of a plurality of seats, issue an instruction of switching the seat surface portion to a first posture to a switching device of each of the seats whose seat surface portion is detected as being in a second posture by a posture determiner, and operate front-rear movement devices of all of the plurality of seats to narrow an interval between the seats after the posture determiner has determined that the seat surface portions of all of the plurality of seats have been switched to the first posture. Here, the first posture corresponds to a raised sitting posture and the second posture corresponds to a sitting posture.

### CROSS-REFERENCE TO RELATED APPLICATIONS

This application claims priority from Japanese Patent Application No. 2018-098612 filed on May 23, 2018 and Japanese Patent Application No. 2018-098610 tiled on May 23, 2018, the entire contents of which are incorporated herein by reference.

### TECHNICAL FIELD

The present disclosure relates to a seat storage system and a seat posture changing system. Specifically, the present disclosure relates to a seat storage system and a seat posture changing system of a seat in which a seat surface portion thereof is switched between a state corresponding to a raised sitting posture and a state corresponding to a sitting posture.

### BACKGROUND

As a seat provided for a vehicle such as an industrial vehicle, there has been known an upright-seat type in which a sitting person can be seated in a standing posture (JP-A-2012-116218). The seat is configured such that a seat surface portion that supports the buttocks of the sitting person is inclined in a shape which is lower on the front side. According to the above configuration, the sitting person can be seated on the seat surface portion in a state in which an angle of the pelvis thereof is close to an angle upon a standing posture, and can take a raised sitting posture in which fatigue feeling is less.

In the related art described above, the seat surface portion cannot be switched so that the sitting person can lower the hips thereof to be seated, and can be used only in the raised sitting posture. Further, there is a need to efficiently store such seat in an unused state in a case where such seat is arranged in plurality in front-rear and left-right directions on a floor and is used in a stadium, a hall, or the like. Further, there is a need to simultaneously switch postures of all seats in a case where such seat is arranged in plurality in front-rear and left-right directions on a floor and is used in a stadium, a hall, or the like.

### SUMMARY

An object to be solved by an aspect of the present disclosure is to efficiently store seats in an unused state in a case where a seat in which a seat surface portion thereof is switched between a state corresponding to a raised sitting posture and a state corresponding to a sitting posture is provided in plurality in front-rear and left-right directions on a floor. Another object to be solved by another aspect of the present disclosure is to simultaneously switch postures of all seats in a case where a seat in which a seat surface portion thereof is switched between a state corresponding to a raised sitting posture and a state corresponding to a sitting posture is provided in plurality in front-rear and left-right directions on a floor.

According to a first aspect of the present disclosure, there is provided a seat storage system including: at least one seat row in which a plurality of seats are arranged so as to be able to move forward and rearward with respect to a pair of left and right fixed rails disposed on a floor in a manner extending in a front-rear direction of the seats, each of the plurality of seats including a seat surface portion configured to be sit on by a sitting person, the seat surface portion being configured to be switched between a first posture corresponding to a raised sitting posture and a second posture corresponding to a sitting posture, wherein each of the plurality of seats includes: a seating determiner configured to determine presence or absence of a sitting person on the seat surface portion; a posture determiner configured to determine whether the seat surface portion is in the first posture or the second posture; a switching device configured to switch the seat surface portion between the first posture and the second posture; and a front-rear movement device configured to move the seat forward and rearward with respect to the pair of left and right fixed rails, wherein the seat storage system includes a controller to which the seating determiner, the posture determiner, the switching device, and the front-rear movement device are connected, and wherein the controller is configured to, in a case where the seating determiner confirms that no sitting person is seated on the seat surface portion of any one of the plurality of seats, issue an instruction of switching the seat surface portion to the first posture to the switching device of each of the seats whose seat surface portion is detected as being in the second posture by the posture determiner, and operate the front-rear movement devices of all of the plurality of seats to narrow an interval between the seats after the posture determiner has determined that the seat surface portions of all of the plurality of seats have been switched to the first posture.

According to the first aspect, the seat surface portion of each seat can be switched between the first posture corresponding to the raised sitting posture and the second posture corresponding to the sitting posture, and the interval in the front-rear direction between seats arranged in plurality in front-rear directions on the floor can be narrowed so as to efficiently store the seats in an unused state in a narrow space.

According to a second aspect of the present disclosure, there is provided a seat posture changing system including: a plurality of seats disposed on a floor and including a first seat, a second seat disposed an a front side or a rear side of the first seat, and a third seat disposed on a left side or a right side of the first seat, each of the plurality of seats including a seat surface portion configured to be sit on by a sitting person, the seat surface portion being configured to be switched between a first posture corresponding to a raised sitting posture and a second posture corresponding to a sitting posture, wherein each of the plurality of seats includes: a posture determiner configured to determine whether the seat surface portion is in the first posture or the second posture; a switching device configured to switch the seat surface portion between the first posture and the second posture; a seating determiner configured to determine presence or absence of a sitting person; and a changing instructor configured to instruct the sitting person to leave the seat and to change the seat surface portion to the first posture or the second posture, wherein the seat storage system includes a controller to which the posture determiner, the switching device, the seating determiner, and the changing instructor are connected, and wherein the controller is configured to: in a case of switching the seat surface portions of all of the plurality of seats to the first posture, determine the seat surface portion in the second posture by the posture determiner, instruct the switching device to switch the seat surface portion determined as being in the second posture to the first posture in a case where the sitting person is determined by the seating determiner as being absent on the seat surface portion determined as being in the second posture, and cause the changing instructor to instruct the sitting person on the seat surface portion determined as being in the second posture to leave the seat and to change the seat surface portion to the first posture in a case where the sitting person is determined by the seating determiner as being present on the seat surface portion determined as being in the second posture; and in a case of switching the seat surface portions of all of the plurality of seats to the second posture, determine the seat surface portion in the first posture by the posture determiner, instruct the switching device to switch the seat surface portion determined as being in the first posture to the second posture in a case where the sitting person is determined by the seating determiner as being absent on the seat surface portion determined as being in the first posture, and cause the changing instructor to instruct the sitting person on the seat surface portion determined as being in the first posture to leave the seat and to change the seat surface portion to the second posture in a case where the sitting person is determined by the seating determiner as being present on the seat surface portion determined as being in the first posture.

According to the second aspect, the seat surface portion of each seat can be switched between the first posture corresponding to the raised sitting posture and the second posture corresponding to the sitting posture, and the seat surface portions of the seats arranged in plurality in front-rear and left-right directions on the floor can be simultaneously switched to the first posture or the second posture.

### BRIEF DESCRIPTION OF DRAWINGS

FIG. 1 is a perspective view of a hall seat according to a first embodiment of the present disclosure;

FIG. 2 is a side view of the hall seat in the first embodiment;

FIG. 3 is a top view showing a state in which the hall seat in the first embodiment is disposed;

FIG. 4 is a top view showing a state in which the hall seat in the first embodiment is disposed and in which a seat cushion of all the seats is set to a raised sitting posture position;

FIG. 5 is a top view showing a state in which the hall seat in the first embodiment is disposed and in which seat cushions of all the seats are set to a raised sitting posture position and front-rear intervals thereof are narrowed;

FIG. 6 is a block diagram showing an operation system of a switching device and a front-rear movement device in the first embodiment;

FIG. 7 is a flow chart showing operation of the switching device and the front-rear movement device in the first embodiment;

FIG. 8 is a perspective view of a hall seat according to a second embodiment of the present disclosure;

FIG. 9 is a side view of the hall seat in the second embodiment;

FIG. 10 is a top view showing a state in which the hall seat in the second. embodiment is disposed;

FIG. 11 is a top view showing a state in which the hall seat in the second embodiment is disposed and in which a seat cushion of all the seats is set to a raised sitting posture position is shown;

FIG. 12 is a block diagram showing an operation system of a switching device in the second embodiment;

FIG. 13 is a flow chart showing operation of the switching device in the second embodiment and a state in which the seat cushions of all the hall seats are set to the raised sitting posture position simultaneously is shown; and

FIG. 14 is a flow chart showing operation of the switching device in the second embodiment and a state in which the seat cushions of all the hall seats are set to the sitting posture position simultaneously is shown.

### DETAILED DESCRIPTION

### First Embodiment

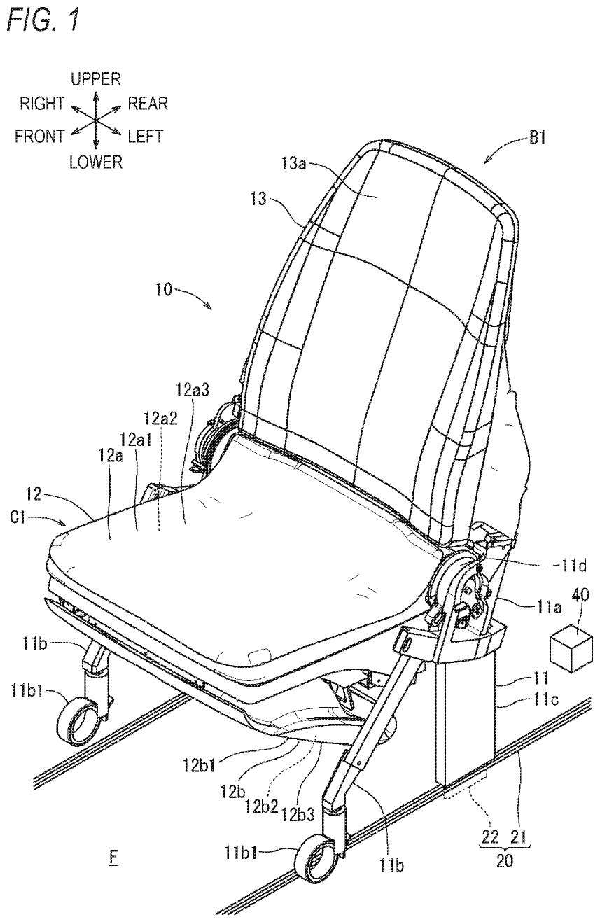

A configuration of a hall seat 10, which is a seat in a seat storage system 1 according to a first embodiment of the present disclosure, will be described with reference to FIGS. 1 to 7. In the following description, each direction, such as front, rear, upper, lower, left, and right, indicates the respective directions shown in the drawings.

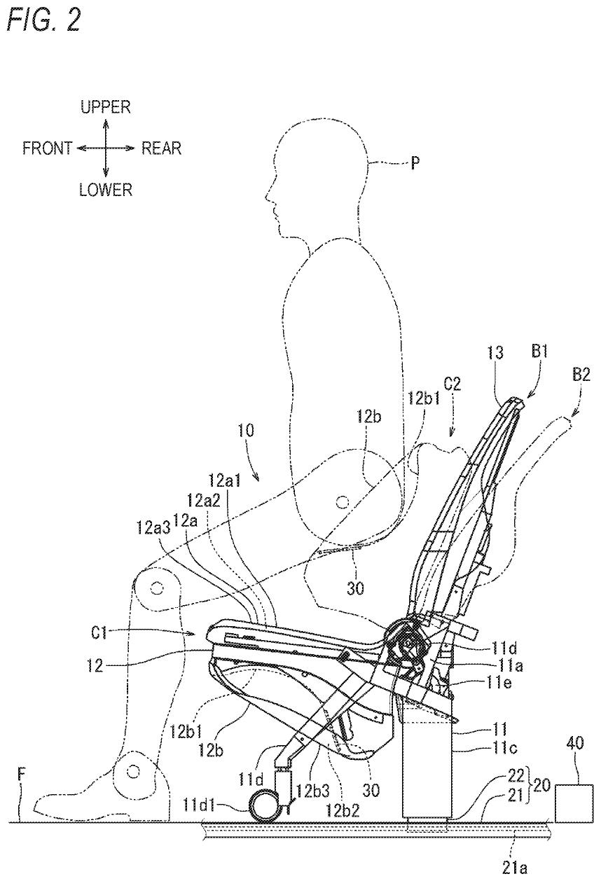

As shown in FIGS. 1 and 2, the hall seat 10 is attached to a floor F via a slide rail 20 so as to be movable in a front-rear direction. Here, the hall seat 10 corresponds to the “seat” in the claims.

The hall seat 10 is configured to include: a frame 11 serving as a framework; a seat cushion 12 supported by the frame 11 and serving as a seating surface; and a seat back 13 supported by the frame 11 and serving as a backrest of a sitting person. Here, the seat cushion 12 corresponds to the “seat surface portion” in the claims.

As shown in FIGS. 1 and 2, the frame 11 is formed by assembling a square pipe member having a rectangular cross section as a main body. The frame 11 includes: a pair of left and right base portions 11a located at a central upper portion in the front-rear direction in a side view; a pair of left and right front leg portions 11b extending obliquely forward and downward respectively from front end portions of the base portions 11a; and a pair of left and right rear leg portions 11c extending downward from rear end portions of the base portions 11a, The pair of left and right base portions 11a are connected by a connecting member extending in a left-right direction (not shown). A first recliner 11d for adjusting a flip-up angle of the seat cushion 12 is disposed on an upper portion of each base portion 11a, and a second recliner 11e for adjusting an inclination angle of the seat back 13 is disposed on a lower portion of each base portion 11a Here, the first recliners 11d corresponds to the “switching device” in the claims.

The first recliners 11d and the second recliners 11e of an electric type are configured to start rotating when an operation button (not shown) disposed on the frame 11 is pressed, and to stop rotating to come into a locked state when a limit switch described later is pressed. A caster 11b1 capable of moving forward and rearward is attached to a lower tip end portion of each front leg portion 11b. The caster 11b1 is rotated in contact with the floor F to change a position of the front leg portion 11b in the front-rear direction. Although not shown in FIGS. 1 and 2, the frame 11 is covered with a cover member made of resin and has a good appearance.

As shown in FIGS. 1 and 2, the seat cushion 12 is formed in a substantially V shape in a side view. Specifically, in a sitting posture position C1 shown by solid lines in FIGS. 1 and 2, a first support surface portion 12a that faces an upper side and a second support surface portion 12b that faces a front lower side are provided. In the seat cushion 12 in the sitting posture position C1, the first support surface portion 12a has a first support surface 12a1 which is an upper surface thereof and formed as a substantially flat surface, and the second support surface portion 12b has a second support surface 12b1 which is a front lower surface thereof and formed as a concave surface whose central portion is recessed in a rear upper direction. A sitting person P can lower the hips thereof to be seated in the sitting posture on the first support surface 12a1 of the seat cushion 12 in the sitting posture position C1. In addition, the second support surface 12b1 forms a lead-in surface that is retracted in a rear-lower shape, so as to form a space to allow a lower leg portion thereof to be led to a rear side when the sitting person P is seated on the first support surface 12a1. The seat cushion 12 is formed by placing cushion pads 12a2 and 12b2, which serve as cushion members, on a cushion frame (not shown) serving as a framework, and covering cushion covers 12a3 and 12b3 serving as skin materials thereon. That is, the first support surface 12a1 of the first support surface portion 12a and the second support surface 12b1 of the second support surface portion 12b are formed to softly contact and support the body of the sitting person P. In the seat cushion 12 in the sitting posture position C1, a rear end portion side of the cushion frame is attached to the base portion 11a of the frame 11 via the first recliners 11d.

When an operation button is pressed in a state in which the seat cushion 12 is in the sitting posture position C1, the seat cushion 12 rotates clockwise around a rotation shaft of the first recliners 11d in FIG. 2, and a front-end side thereof is flipped up. When flipped up from the sitting posture position C1 to the rear side by 90 degrees or more and coming into a raised sitting posture (that is, sitting in a standing posture) position C2 shown by a two-dot chain line in FIG. 2, the seat cushion 12 presses a limit switch 11f (see FIG. 6) disposed on the frame 11, and thereby the first recliners 11d are stopped from rotating and come into a locked state. At this time, the second support surface portion 12b is raised to a position higher than the first support surface portion 12a in the sitting posture position C1, and the second support surface 12b1 forms a surface inclined in a shape which is lower on the front side and is capable of contacting and supporting the buttocks of the sitting person P. The second support surface 12b1 forming the seating surface in the raised sitting posture position C2 forms a surface of a shape which is lower on the front side, thereby opposing a wide surface with respect to the buttocks of the sitting person P taking the raised sitting posture, and thus a front edge portion thereof is unlikely to form a protruding shape that bites into the buttocks of the sitting person P. Therefore, the sitting person P seated on the second support surface portion 12b can take the raised sitting posture in which fatigue feeling is less at an angle of the pelvis close to an angle in the standing posture, with lower foreign matter feeling and good sitting comfort. Here, the sitting posture position C1 and the raised sitting posture position C2 correspond to the “second posture” and the “first posture” in the claims, respectively. The limit switch 11f corresponds to the “posture determiner” in the claims.

As shown in FIG. 2, the second support surface portion 12b is provided with a seating sensor 30. The seating sensor 30 is disposed by being embedded at a position in the cushion pad 12b2 corresponding to the pelvis of the sitting person P when the sitting person P is seated while the seat cushion 12 is in the raised sitting posture position C2. Specifically, the seating sensor 30 has a rectangular surface shape, and is disposed between the cushion cover 12b3 and the cushion pad 12b2. The seating sensor 30 outputs a signal to a computer 40 described later when the sitting person P is seated on the second support surface 12b1. Here, the seating sensor 30 corresponds to the “seating determiner” in the claims.

As shown in FIGS. 1 and 2, the seat back 13 is formed into a substantially vertical 1 shape in a side view. Specifically, in a sitting posture position B1 shown by solid lines in FIGS. 1 and 2, a front surface serving as a backrest surface thereof forms a substantially flat inclined surface inclined slightly rearward than vertical. The front surface of the seat back 13 in the sitting posture position B1 can support from behind the back portion of the sitting person P seated in the sitting posture with the hips thereof lowered. The seat back 13 is formed by placing a back pad, which serves as a cushion member, on a back frame (not shown) serving as a framework, and covering a back cover 13a serving as a skin material thereon. That is, the front surface portion of the seat back 13 is formed to softly contact and support the body of the sitting person P. In the seat back 13, a lower end portion side of the back frame is attached to the base portion 11a of the frame 11 via the second recliners 11e.

When an operation button is pressed in a state in which the seat cushion 12 is in the sitting posture position C1 and the seat back 12 is in the sitting posture position B1, the seat back 13 rotates clockwise around a rotation shaft of the second recliners 11e in FIG. 2 and is tilted rearward. When coming into a raised sitting posture position B2 shown by a two-dot chain line in FIG. 2, the seat back 13 presses a limit switch (not shown) disposed on the frame 11, and thereby the second recliners lie are stopped from rotating and comes into a locked state. At this time, the seat back 13 is at a position without in contact with the seat cushion 12 in the raised sitting posture position C2. The seat back 13 moves from the sitting posture position B1 to the raised sitting posture position B2 in a shorter time than a time that the seat cushion 12 moves from the sitting posture position C1 to the raised sitting posture position C2. As a result, the seat cushion 12 and the seat back 13 do not interfere with each other during a process in which the seat cushion 12 moves from the sitting posture position C1 to the raised sitting posture position C2 and the seat back 13 moves from the sitting posture position B1 to the raised sitting posture position B2. The seat back 13 does not contact the body of the sitting person P when the seat back 13 is in the raised sitting posture position B2. The seat cushion 12 and the seat back 13 are movable between the sitting posture positions C1, B1 and the raised sitting posture positions C2, B2 also by a signal from the computer 40 installed at a predetermined position on the floor F, which will be described later. That is, the first recliners 11d and the second recliners 11e can be operated not only by the operation buttons but also by a signal from the computer 40.

As shown in FIGS. 1 to 4, on the floor F, pairs of left and right slide rails 20 are provided in plurality so as to extend in the front-rear direction parallel to each other. Each pair of left and right slide rails 20 are arranged so as to be placed between the casters 11b1 of the front leg portions 11b of the hall seat 10. As shown in FIG. 2, each slide rail 20 has a lower rail 21 that is long and fixed to the floor F and an upper rail 22 that is short and slidably attached to the lower rail 21 in a direction in Which the lower rail 21 extends. A screw 21a extending in the front-rear direction is disposed inside the lower rail 21. A plurality of upper rails 22 are attached to each lower rail 21, and each of the upper rails 22 is attached so as to be movable forward and rearward via a nut (not shown) that is screwed to the screw 21a and rotated by motor drive. A motor of the upper rail 22 can be reversibly rotated by an operation switch (not shown) attached to the frame 11. A lower end portion of each rear leg portion 11c of the hall seat 10 is attached to each of the upper rails 22. Accordingly, each of the hall seats 10 can be moved in the front-rear direction with respect to the pair of left and right slide rails 20 by operation of the operation switch, and can be made unmovable in the front-rear direction by stopping rotation of the nut at a desired position. At this time, the casters 11b1 are respectively disposed on the outer sides of the pair of left and right slide rails 20 in a seat width direction, and thus can smoothly move on the floor F. Each of the hall seats 10 is configured to automatically stop motor drive and to stop rotation of the nuts in a case where an interval from a front seat reaches a predetermined value due to operation of the upper rails 22. The upper rails 22 can be moved in the front-rear direction also by a signal from the computer 40 installed at the predetermined position on the floor F, which will be described later. That is, the upper rails 22 can be operated not only by the operation switch but also by a signal from the computer 40. Here, the lower rails 21 and the upper rails 22 respectively correspond to the “fixed rail” and the “front-rear movement device” in the claims. A state in which the hall seats 10 are arranged in a row in the front-rear direction on the pair of left and right slide rails 20 corresponds to the “seat row” in the claims.

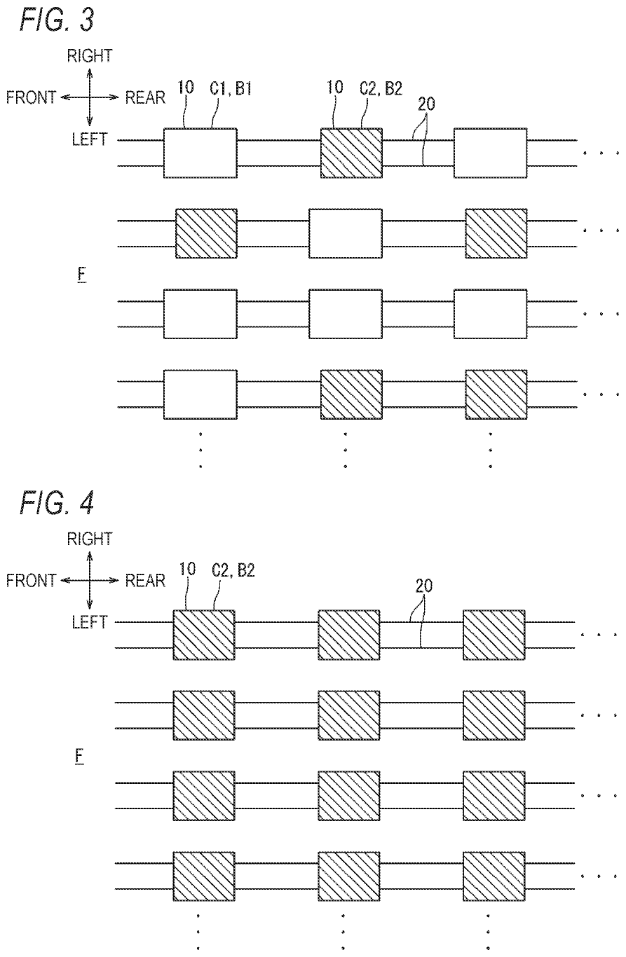

Operation of the hall seat 10 will be described. In a normal state, the sitting person P of each seat uses the hall seat 10 by freely selecting a state in which the seat cushion 12 is in the sitting posture position C1 and the seat back 13 is in the sitting posture position B1 or a state in which the seat cushion 12 is in the raised sitting posture position C2 and the seat back 13 is in the raised sitting posture position B2. That is, the sitting person P of each seat uses the hall seat 10 by freely switching the sitting posture positions C1, B1 and the raised sitting posture positions C2, B2 by operating the first recliners 11d and the second recliners 11e via the operation buttons. As shown in FIG. 3, in a normal state, the state in which the seat cushion 12 is in the sifting posture position C1 and the seat back 13 is in the sitting posture position 31 and the state in which the seat cushion 12 is in the raised sitting posture position C2 and the seat back 13 is in the raised sitting posture position B2 coexist irregularly. The intervals between the hall seats 10 in the front-rear direction are set to intervals that can be suitably used by the sitting person P of each of the hall seats 10.

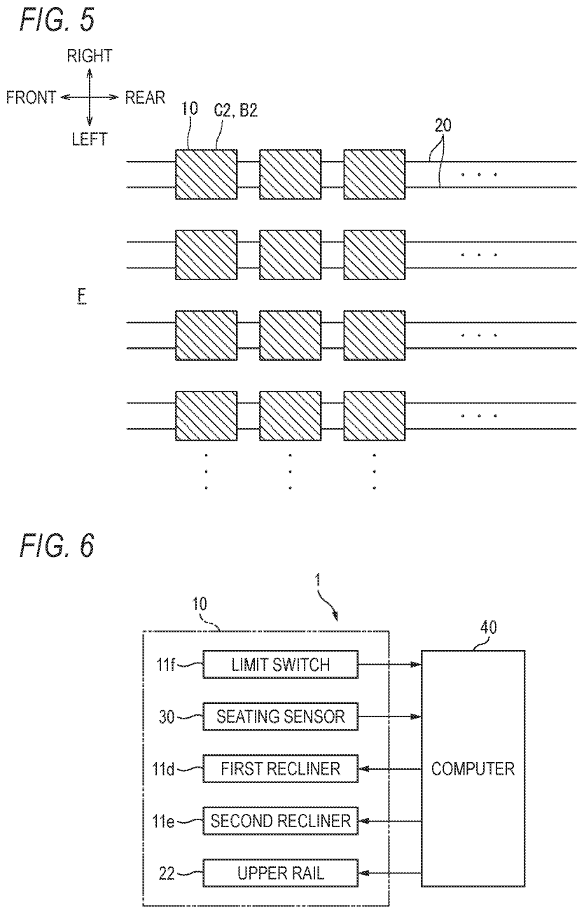

Operation of the first recliners 11d and the second recliners 11e will be described with reference to FIGS. 5 to 7. FIG. 6 is a block diagram of the seat storage system 1 in a case where operation of the first recliners 11d and the second recliners 11e is performed by the program-controlled computer 40. The computer 40 is installed at the predetermined position on the floor F of the hall, and receives a detection signal from the limit switch 11f and the seating sensor 30 of the seat cushion 12. The first recliners 11d, the second recliners 11e, and the upper rails 22 are connected to the computer 40 so as to be operable. Here, the computer 40 corresponds to the “controller” in the claims.

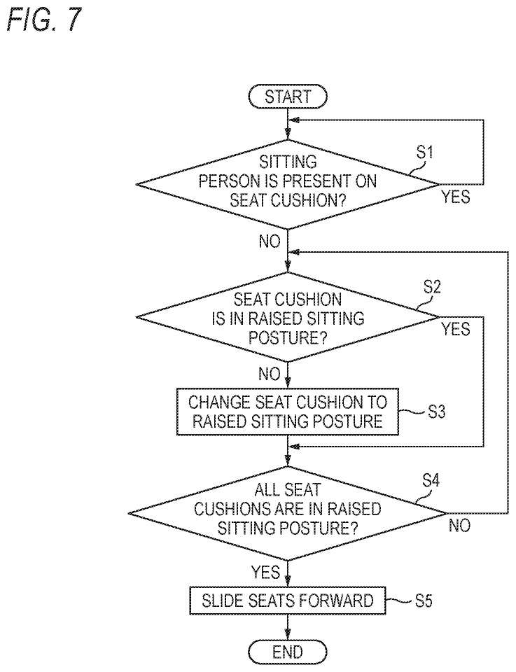

FIG. 7 is a flowchart of the seat storage system 1 in which the first recliners 11d and the second recliners 11e of each of the hall seats 10 are operated to set the seat cushions 12 and the seat backs 13 of all the hall seats 10 to the raised sitting posture positions C2, B2, and the upper rails 22 are operated to narrow the intervals between the hall seats 10. In step S1, whether or not a sitting person P is present on the second support surface 12b1 of each of the hall seats 10 is determined via a detection signal from the seating sensor 30. In a case where a sitting person P is present on the second support surface 12b1, the process returns to step S1, and in a case where a sitting person P is not present on the second support surface 12b1, the process proceeds to step S2.

In step S2, whether or not the seat cushion 12 is in the raised sitting posture position C2 is determined via a detection signal from the limit switch 11f. In each of the hall seats 10, in a case where the seat cushion 12 is in the raised sitting posture position C2, the process proceeds to step S4, and in a case where the seat cushion 12 is not in the raised sitting posture position C2, the process proceeds to step S3 and the first recliners 11d and the second recliners 11e are operated to set the seat cushion 12 and the seat back 13 of the hall seat 10 to the raised sitting posture positions C2, B2.

In step S4, whether or not the seat cushions 12 of all the hall seats 10 are in the raised sitting posture position C2 is determined via detection signals from the limit switches 11f. In a case where even one of the seat cushions 12 is not at the raised sitting posture position C2, the process returns to step S2. In a case where the seat cushions 12 of all the hall seats 10 are at the raised sitting posture position C2. the process proceeds to step 55, and the upper rails 22 of each of the hall seats 10 are operated to narrow the intervals between the seats in the front-rear direction. FIG. 4 shows a state in which the seat cushions 12 and the seat backs 13 of all the hall seats 10 are in the raised sitting posture positions C2, B2 in Step S4. Further, FIG. 5 shows a state in which the intervals between all the hall seats 10 in the front-rear direction is narrowed through step 55.

The first embodiment configured as described above has the following advantageous effects. In each of the hall seats 10, the seat cushion 12 is switched between the raised sitting posture position C2 corresponding to the raised sitting posture and the sitting posture position C1 corresponding to the sitting posture, and the seat cushions 12 and the seat backs 13 of the hall seats 10, which are provided in plurality in the front-rear and the left-right directions on the floor F, can be set to the raised sitting posture positions C2, B2, so as to narrow the intervals of the hall seats 10 in the front-rear direction. As a result, the ball seats 10 in the unused state can be efficiently stored in a narrow space.

### Second Embodiment

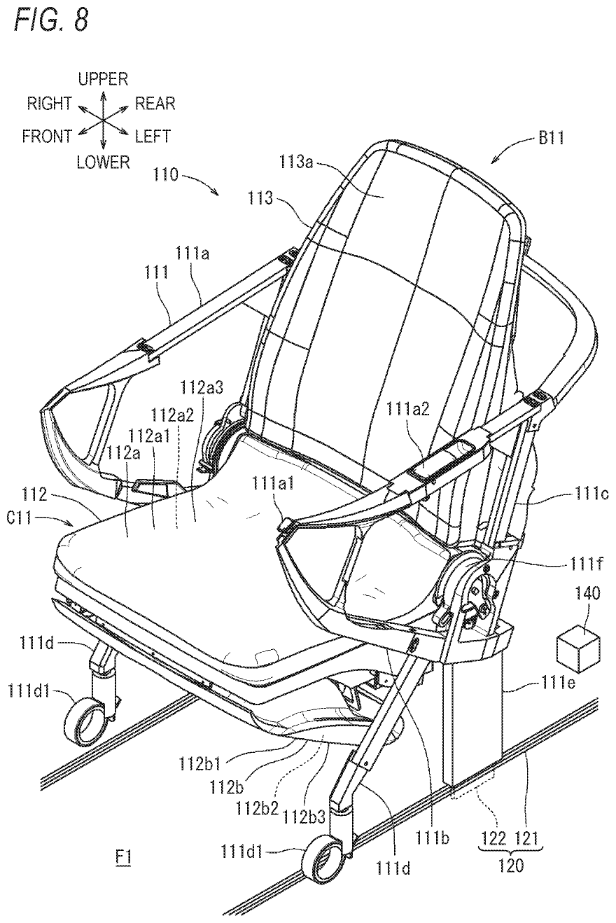

A configuration of a hall seat 110, which is a seat in a seat posture changing system 101 according to a second embodiment of the present disclosure, will be described with reference to FIGS. 8 to 14. In the following description, each direction, such as front, rear, upper, lower, left, and right, indicates the respective directions shown in the drawings.

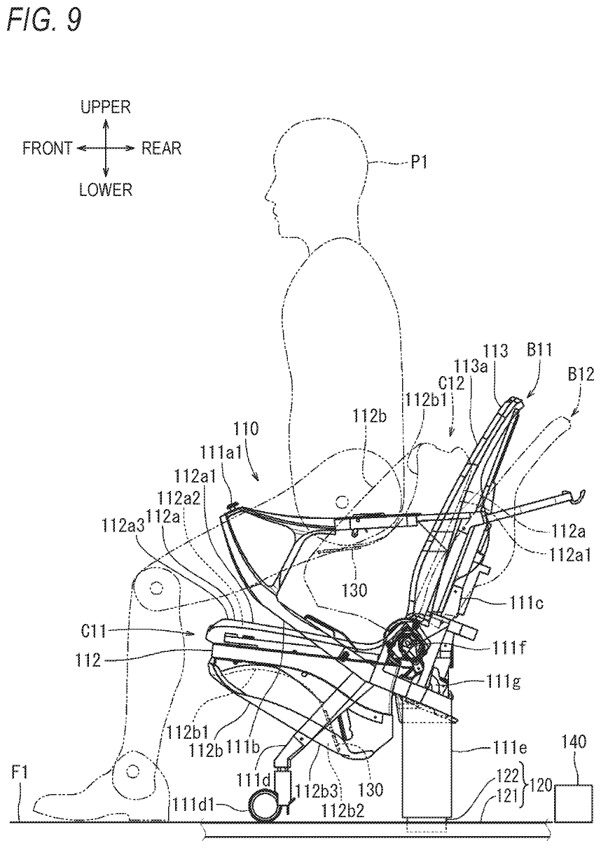

As shown in FIGS. 8 and 9, the hall seat 110 is attached to a floor F1 via a slide rail 120 so as to be movable in a front-rear direction. Here, the hall seat 110 corresponds to the “seat” in the claims.

The hall seat 110 is configured to include: a frame 111 serving as a framework; a seat cushion 112 supported by the frame 111 and serving as a seating surface; and a seat back 113 supported by the frame 111 and serving as a backrest of a sitting person. Here, the seat cushion 112 corresponds to the “seat surface portion” in the claims.

As shown in FIGS. 8 and 9, the frame 111 is formed by assembling a square pipe member having a rectangular cross section as a main body. The frame 111 includes an upper frame portion 111a which is formed in a substantially U-shape having an opening at a front side in a top view and extends substantially horizontally, a lower frame portion 111b which is formed in a substantially U-shape having an opening at the front side in the top view and extends obliquely rearward and downward by connecting the opening end to the opening end of the upper frame portion 111a, a pair of left and right connecting portions 111c which respectively connect portions slightly behind center portions in the front-rear direction of the upper frame portion 111a and a rear end portion of the lower frame portion 111b in a substantially vertical direction, a pair of left and right front leg portions 111d which respectively extend obliquely forward and downward from the portions slightly behind the center portions in the front-rear direction of the lower frame portion 111b, and rear leg portions 111e extending downward from the rear end portion of the lower frame portion 111b. On a lower portion of each connecting portion 111c, a first recliner 111f for adjusting a flip-up angle of the seat cushion 112 is disposed at a position upper than the lower frame portion 111b, and a second recliner 111a for adjusting an inclination angle of the seat back 113 is disposed at a position at a height approximately the same as the lower frame portion 111b. As will be described later, a display for instructing the sitting person to operate the first recliners 111f to change the posture of the seat cushion 112 is disposed on an upper surface of a left side portion of the upper frame portion 111a. Here, the first recliners 111f correspond to the “switching device” in the claims, and the display 111a2 corresponds to the “changing instructor” in the claims.

The first recliner 111f and the second recliner 111g of an electric type are configured to start rotating when an operation button (not shown) disposed on the frame 111 is pressed, and to stop rotating to conic into a locked state when a limit switch (to be described later) is pressed. A caster 111d1 capable of moving forward and rearward is attached to a lower tip end portion of each front leg portion 111d. The caster 111d1 is rotated in contact with the floor F1 to change a position of the front leg portion 111d in the front-rear direction. Although not shown in FIGS. 8 and 9, the frame 111 is covered with a cover member made of resin and has a good appearance.

As shown in FIGS. 8 and 9, the seat cushion 112 is formed in a substantially V shape in a side view Specifically, in a sitting posture position C11 shown by solid lines in FIGS. 8 and 9, a first support surface portion 112a that faces an upper side and a second support surface portion 112b that faces a front lower side are provided. In the seat cushion 112 in the sitting posture position C11, the first support surface portion 112a has a first support surface 112a1, which is an upper surface thereof and formed as a substantially flat surface, and the second support surface portion 112b has a second support surface 112b1, which is a front lower surface thereof and formed as a concave surface whose central portion is recessed in a rear upper direction. A sitting person P1 can be seated in the sitting posture on the first support surface 112a1 of the seat cushion 112 in the sitting posture position C11. In addition, the second support surface 112b1 forms a lead-in surface that is retracted in a rear-lower shape, so as to form a space to allow a lower leg portion thereof to be led to a rear side when the sitting person P1 is seated on the first support surface 112a1. The seat cushion 112 is formed by placing cushion pads 112a2 and 112b2, which serve as cushion members, on a cushion frame (not shown) serving as a framework, and covering cushion covers 112a3 and 112b3 serving as skin materials thereon. That is, the first support surface 112a1 of the first support surface portion 112a and the second support surface 112b1 of the second support surface portion 112b are formed to softly contact and support the body of the sitting person P1. In the seat cushion 112 in the sitting posture position C11, a rear end portion side of the cushion frame is attached to the connecting portions 111c of the frame 111 via the first recliners 111f.

When an operation button is pressed in a state in which the seat cushion 112 is in the sitting posture position C11, the seat cushion 112 rotates clockwise around a rotation shaft of the first recliners 111f in FIG. 9, and a front-end side thereof is flipped up. When flipped up from the sitting posture position C11 to the rear side by 90 degrees or more and coming into a raised sitting posture position (that is, sitting in a standing posture) C12 shown by a two-dot chain line in FIG. 9, the seat cushion 112 presses a limit switch 111h (see FIG. 12) disposed on the frame 111, and thereby the first recliners 111f are stopped from rotating and come into a locked state. At this time, the second support surface portion 112b is raised to a position higher than the first support surface portion 112a in the sitting posture position C11, and the second support surface 112b1 forms a surface inclined in a shape which is lower on the front side and is capable of contacting and supporting the buttocks of the sitting person P1. The second support surface 112b1 forming the seating surface in the raised sitting posture position C12 forms a surface of a shape which is lower on the front side, thereby opposing a wide surface with respect to the buttocks of the sitting person P1 taking the raised sitting posture, and thus a front edge portion thereof is unlikely to form a protruding shape that bites into the buttocks of the sitting person P1. Therefore, the sitting person P1 seated on the second support surface portion 112b can take the raised sitting posture in which fatigue feeling is less at an angle of the pelvis close to an angle in the standing posture, with lower foreign matter feeling and good sitting comfort. Here, the sitting posture position C11 and the raised sitting posture position C12 correspond to the “second posture” and the “first posture” in the claims, respectively. The limit switch 111h corresponds to the “posture determiner” in the claims.

As shown in FIG. 9, the second support surface portion 112b is provided with a seating sensor 130. The seating sensor 130 is disposed by being embedded at a position in the cushion pad 112b2 corresponding to the pelvis of the sitting person P1 when the sitting person P1 is seated while the seat cushion 112 is in the raised sitting posture position C12. Specifically, the seating sensor 130 has a rectangular surface shape, and is disposed between the cushion cover 112b3 and the cushion pad 112b2. The seating sensor 130 outputs a signal to a computer 140 described later when the sitting person P1 is seated on the second support surface 112b1. Here, the seating sensor 130 and the computer 140 correspond to the “seating determiner” and the “controller” the in the claims, respectively.

As shown in FIGS. 8 and 9, the seat back 113 is formed into a substantially vertical 1 shape in a side view. Specifically, in a sitting posture position B11 shown by solid lines in FIGS. 8 and 9, a front surface serving as a backrest surface thereof forms a substantially flat inclined surface inclined slightly rearward than vertical. The front surface of the seat back 113 in the sitting posture position B11 can support from behind the back portion of the sitting person P1 seated in the sitting posture with the hips thereof lowered. The seat back 113 is formed by placing a back pad, which serves as a cushion member, on a back frame (not shown) serving as a framework, and covering a back cover 113a serving as a skin material thereon. That is, the front surface portion of the seat back 113 is formed to softly contact and support the body of the sitting person P1. In the seat back 113, a lower end portion side of the back frame is attached to the connecting portions 111c of the frame 111 via the second recliners 111g.

When an operation button is pressed in a state in which the seat cushion 112 is in the sitting posture position C11 and the seat back 112 is in the sitting posture position B11, the seat back 113 rotates clockwise around a rotation shaft of the second recliners 111g in FIG. 9 and is tilted rearward. When coming into a raised sitting posture position B12 shown by a two-dot chain line in FIG. 9, the seat back 113 presses a limit switch (not shown) disposed on the frame 111, and thereby the second recliners 111g are stopped from rotating and comes into a locked state. At this time, the seat back 113 is at a position without in contact with the seat cushion 112 in the raised sitting posture position C12.

The seat back 113 moves from the sitting posture position B11 to the raised sitting posture position B12 in a shorter time than a time that the seat cushion 112 moves from the sitting posture position C11 to the raised sitting posture position C12. As a result, the seat cushion 112 and the seat back 113 do not interfere with each other during a process in which the seat cushion 112 moves from the sitting posture position C11 to the raised sitting posture position C12 and the seat back 113 moves from the sitting posture position B11 to the raised sitting posture position B12. The seat back 113 does not contact the body of the sitting person P1 when the seat back 113 is in the raised sitting posture position B12. The seat cushion 112 and the seat back 113 are movable between the sitting posture positions C11, B11 and the raised sitting posture positions C12, B12 also by a signal from the computer 140 installed at a predetermined position on the floor F1, which will be described later. That is, the first recliners 111f and the second recliners 111g can be operated not only by the operation buttons but also by a signal from the computer 140.

As shown in FIGS. 8 to 11, on the floor F1, pairs of left and right slide rails 120 are provided in plurality so as to extend in the front-rear direction parallel to each other. Each pair of left and right slide rails 120 are arranged so as to be placed between the casters 111d1 of the front leg portions hid of the hall seat 110. As shown in FIG. 9, each slide rail 120 has a lower rail 121 that is long and fixed to the floor F1 and upper rails 122 that are short and slidably attached to the lower rail 121 in a direction in which the lower rail 121 extends. A plurality of the upper rails are attached with respect to each lower rail 121, and lower end portions of the rear leg portions 111e of the hall seats 110 are respectively attached to the upper rails 122. Further, a lock mechanism (not shown) capable of locking and unlocking sliding of the upper rail 122 with respect to the lower rail 121 is disposed on each upper rail 122. Accordingly, each of the hall seats 110 can be moved in the front-rear direction with respect to the pair of left and right slide rails 120, and can be locked and made unmovable in the front-rear direction at a desired position. At this time, the casters 111d1 are respectively disposed on the outer sides of the pair of left and right slide rails 120 in a seat width direction, and thus can smoothly move on the floor F1.

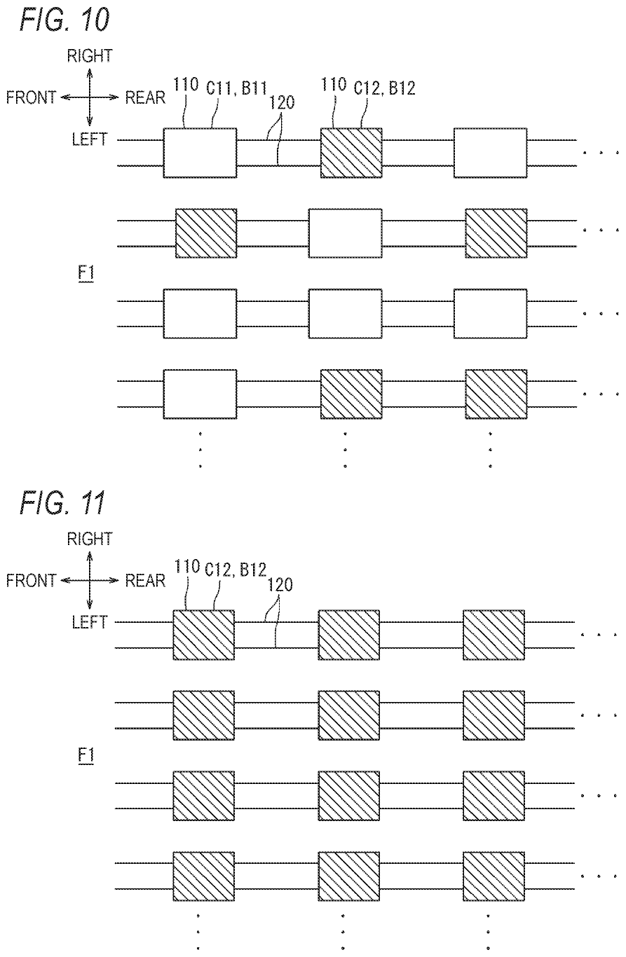

Operation of the hall seat 110 will be described. In a normal state, the sitting person of each seat freely selects and uses a state in which the seat cushion 112 is in the sitting posture position C11 and the seat back 113 is in the sitting posture position 311 or a state in which the seat cushion 112 is in the raised sitting posture position C12 and the seat back 113 is in the raised sitting posture position B12. That is, the sitting person P1 of each seat uses the hall seat 110 by freely switching the sitting posture positions C11, B11 and the raised sitting posture positions C12, B12 by operating the first recliners 111f and the second recliners 111g via the operation buttons. As shown in FIG. 10, in a normal state, the state in which the seat cushion 112 is in the sitting posture position C11 and the seat back 113 is in the sitting posture position B11 and the state in which the seat cushion 112 is in the raised sitting posture position C12 and the seat back 113 is in the raised sitting posture position B12 coexist irregularly.

Operation of the first recliners 111f and the second recliners 111g will be described with reference to FIGS. 12 to 14. FIG. 12 is a block diagram of the seat posture changing system 101 in a case where operation of the first recliners 111f and the second recliners 111a is performed by the program-controlled computer 140. The computer 140 is installed at the predetermined position on the floor F1 of the hall, and receives a detection signal from the limit switch 111h and the seating sensor 130 of the seat cushion 112. The first recliners 111f and the second recliners 111g are connected to the computer 140 so as to be operable.

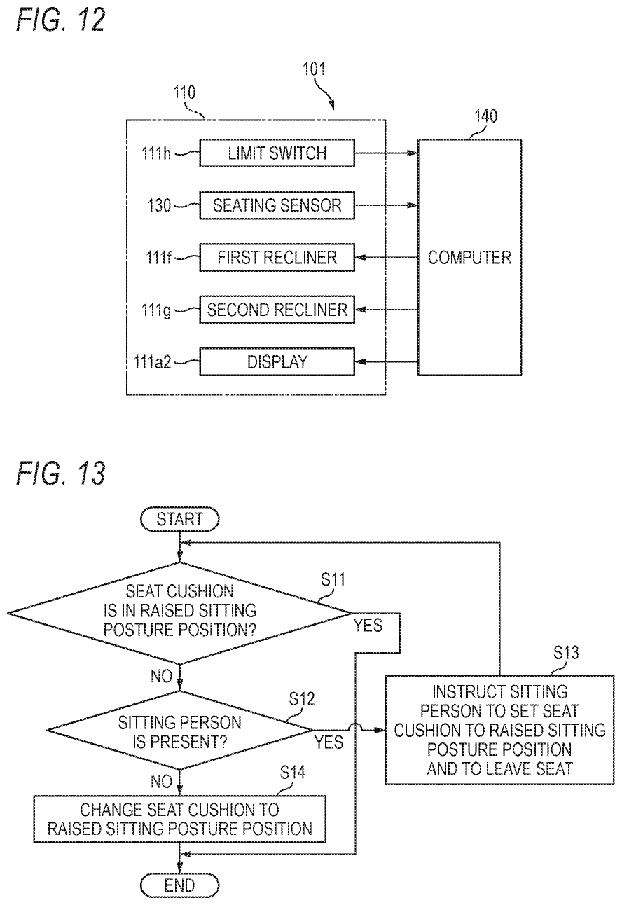

FIG. 13 is a flowchart in which the first recliners 111f and the second recliners 111g of each of the hall seat 110 are operated to set the seat cushions 112 and the seat backs 113 of all the hall seats 110 to the raised sitting posture positions C12, B12. in step S11, whether or not the seat cushion 112 of each of the hall seats 110 is in the raised sitting posture position C12 is determined via a detection signal from the limit switch 111h. In each of the hall seats 110, in a case where the seat cushion 112 is in the raised sitting posture position C12, the process is ended, and in a case where the seat cushion 112 is not in the raised sitting posture position C12, the process proceeds to step S12.

In step S12, whether or not a sitting person P1 is present on the second support surface 112b1 of the seat cushion 112 in each of the hall seats 110 whose seat cushion 112 is not in the raised sitting posture position C12 is determined via a detection signal from the seating sensor 130. In a case where a sitting person P1 is present on the second support surface 112b1, the process proceeds to step S13, and the display 111a2 instructs the sitting person P1 to set the seat cushion 112 to the raised sitting posture position C12 and to leave the seat. Specifically, a text “Please set the seat to the raised sitting posture and leave the seat” is displayed on a screen of the display 111a2. Then, the process returns to step S11. In a case where a sitting person P1 is not on the second support surface 112b1, the process proceeds to step S14, and the first recliners 111f and the second recliners 111g are operated to set the seat cushions 112 and the seat backs 113 of all the hall seats 110 to the raised sitting posture positions C12, B12. FIG. 11 shows a state in which the seat cushions 112 and the seat backs 113 of all the hall seats 110 are set to the raised sitting posture positions C12, B12 in this way.

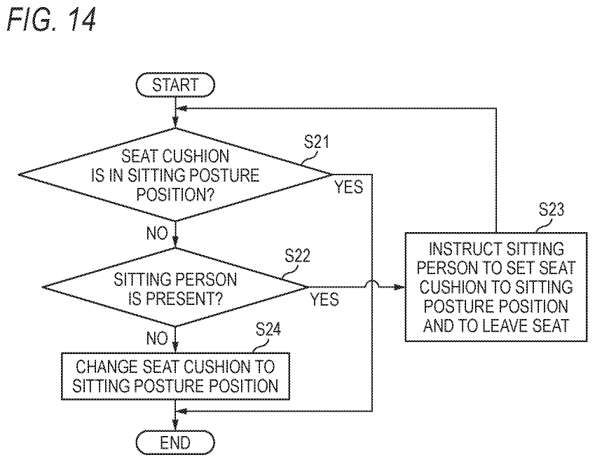

FIG. 14 is a flowchart in which the first recliners 111f and the second recliners 111g of each of the hall seat 110 are operated to set the seat cushions 112 and the seat hacks 113 of all the hall seats 110 to the sitting posture positions C11, B11. In step S21, whether or not the seat cushion 112 of each of the hall seats 110 is in the sitting posture position C11 is determined via a detection signal from the limit switch 111h. In each of the hall seats 110, in a case where the seat cushion 112 is in the sitting posture position C11, the process is ended, and in a case where the seat cushion 112 is not in the sitting posture position C11, the process proceeds to step S22.

In step S22, whether or not a sitting person P1 is present on the second support surface 112b1 of the seat cushion 112 in each of the hall seats 110 whose seat cushion 112 is not in the sitting posture position C11 is determined via a detection signal from the seating sensor 130. In a case where a sitting person P1 is present on the second support surface 112b1, the process proceeds to step S23, and the display 111a2 instructs the sitting person P1 to set the seat cushion 112 to the sitting posture position C11 and to leave the seat. Specifically, a text “Please set the seat to the sitting posture and leave the seat” is displayed on the screen of the display 111a2. Then, the process returns to step S21. In a case where a sitting person P1 is not on the second support surface 112b1, the process proceeds to step S24, and the first recliners 111f and the second recliners 111g are operated to set the seat cushions 112 and the seat backs 113 of all the hall seats 110 to the sitting posture positions C11, B11.

The second embodiment configured as described above has the following advantageous effects. In each of the hall seats 110, the seat cushion 112 is switched between the raised sitting posture position C12 corresponding to the raised sitting posture and the sitting posture position C11 corresponding to the sitting posture, and the seat cushions 112 and the seat backs 113 of the hall seats 110, which are provided in plurality in the front-rear and the left-right directions on the floor F1, can be simultaneously switched to the raised sitting posture positions C12, B12 or the sitting posture positions C11, B11.

While certain embodiments have been described, the present disclosure is not limited to these configurations, and various modifications, additions, and deletions may be made without departing from the scope of the present disclosure. Examples thereof include the following.

1. In the above-described first embodiment, the seat back 13 is configured to move in conjunction with the seat cushion 12, but is not limited thereto, and the seat back 13 may be fixed to the frame. Similarly, in the above-described second embodiment, the seat back 113 is configured to move in conjunction with the seat cushion 112, but is not limited thereto, and the seat back 113 may be fixed to the frame.

2. In the above-described first embodiment, the frame 11 is configured to be supported by the pair of left and right front leg portions 11b and the pair of left and right rear leg portions 11c, but is not limited thereto, and may be configured to be supported by only the pair of left and right rear leg portions 11c with respect to the floor F.

3. In the above-described second embodiment, each of the hall seats 110 is attached to the floor F1 via the slide rails 120 and is movable in the front-rear direction, but is not limited thereto, and may also be fixed to the floor F1.

What is claimed is:

1. A seat storage system comprising:
at least one seat row in which a plurality of seats are arranged so as to be able to move forward and rearward with respect to a pair of left and right fixed rails disposed on a floor in a manner extending in a front-rear direction of the seats, each of the plurality of seats including a seat surface portion configured to be sit on by a sitting person, the seat surface portion being configured to be switched between a first posture corresponding to a raised sitting posture and a second posture corresponding to a sitting posture,
wherein each of the plurality of seats includes:
a seating determiner configured to determine presence or absence of a sitting person on the seat surface portion;
a posture determiner configured to determine whether the seat surface portion is in the first posture or the second posture;
a switching device configured to switch the seat surface portion between the first posture and the second posture; and
a front-rear movement device configured to move the seat forward and rearward with respect to the pair of left and right fixed rails,
wherein the seat storage system includes a controller to which the seating determiner, the posture determiner, the switching device, and the front-rear movement device are connected, and
wherein the controller is configured to, in a case where the seating determiner confirms that no sitting person is seated on the seat surface portion of any one of the plurality of seats, issue an instruction of switching the seat surface portion to the first posture to the switching device of each of the seats whose seat surface portion is detected as being in the second posture by the posture determiner, and operate the front-rear movement devices of all of the plurality of seats to narrow an interval between the seats after the posture determiner has determined that the seat surface portions of all of the plurality of seats have been switched to the first posture.

2. A seat posture changing system comprising:
a plurality of seats disposed on a floor and including a first seat, a second seat disposed an a front side or a rear side of the first seat, and a third seat disposed on a left side or a right side of the first seat, each of the plurality of seats including a seat surface portion configured to be sit on by a sitting person, the seat surface portion being configured to be switched between a first posture corresponding to a raised sitting posture and a second posture corresponding to a sitting posture,
wherein each of the plurality of seats includes:
a posture determiner configured to determine whether the seat surface portion is in the first posture or the second posture;
a switching device configured to switch the seat surface portion between the first posture and the second posture;
a seating determiner configured to determine presence or absence of a sitting person; and
a changing instructor configured to instruct the sitting person to leave the seat and to change the seat surface portion to the first posture or the second posture,
wherein the seat storage system includes a controller to which the posture determiner, the switching device, the seating determiner, and the changing instructor are connected, and
wherein the controller is configured to:
in a case of switching the seat surface portions of all of the plurality of seats to the first posture, determine the seat surface portion in the second posture by the posture determiner, instruct the switching device to switch the seat surface portion determined as being in the second posture to the first posture in a case where the sitting person is determined by the seating determiner as being absent on the seat surface portion determined as being in the second posture, and cause the changing instructor to instruct the sitting person on the seat surface portion determined as being in the second posture to leave the seat and to change the seat surface portion to the first posture in a case where the sitting person is determined by the seating determiner as being present on the seat surface portion determined as being in the second posture; and
in a case of switching the seat surface portions of all of the plurality of seats to the second posture, determine the seat surface portion in the first posture by the posture determiner, instruct the switching device to switch the seat surface portion determined as being in the first posture to the second posture in a case where the sitting person is determined by the seating determiner as being absent on the seat surface portion determined as being in the first posture, and cause the changing instructor to instruct the sitting person on the seat surface portion determined as being in the first posture to leave the seat and to change the seat surface portion to the second posture in a case where the sitting person is determined by the seating determiner as being present on the seat surface portion determined as being in the first posture.
